(19) United States
(12) Patent Application Publication
(10) Pub. No.: US 2014/0212201 A1
(43) Pub. Date: Jul. 31, 2014

(54) Storage System

(71) Applicant: Marie Ireland, Kaitaia (NZ)

(72) Inventor: Marie Ireland, Kaitaia (NZ)

(21) Appl. No.: 14/238,521

(22) PCT Filed: Aug. 30, 2012
(86) PCT No.: PCT/AU2012/001025

§ 371 Date: Feb. 12, 2014

(30) Foreign Application Priority Data
Aug. 31, 2011 (NZ) 594938

(51) Int. Cl. B42F 3/04

(52) U.S. Cl. CPC B42F 3/04
USPC 402/70

(57) ABSTRACT

The present invention is directed to a storage system for storing documents. The storage system comprises securing means for securing the documents, a carriage for carrying the securing means, the carriage having location means for locating the securing means, and a support structure from which the carriage can be extended so that a face of the secured documents can be viewed.

TECHNICAL FIELD

The invention described herein relates to a storage system. In particular, the invention is directed to a storage system for storing documents.

### BACKGROUND ART

Conventionally, shelves have been used for the storage of books, documents, files and other objects. In an office, adjacent files stored on a shelf bear identifying labels and/or tags.

One disadvantage of conventional shelves is that the file face and internal documents are hidden and it can sometimes be difficult and time consuming to locate the correct document, particularly when the files are not labelled or are labelled incorrectly.

In more recent times, filing cabinets have been used for the storage of documents. Each filing cabinet comprises a support structure. The support structure carries one or more extendable carriages in the form of draws. Each draw has two support bars extending along the direction of extension of the draw. Separate suspension folders can be used to hold loose documents. The suspension folders each have a pair of hangers which hang over the support bars. Each suspension folder may have tabs and labels identifying the contents of the suspension folder. Invariably, labels are removed or incorrect, in which case many folders must be searched to locate the required documents.

It is an object of the present invention to provide an improved means Co locate a document irrespective of labelling.

### SUMMARY OF THE INVENTION

In one broad form, the invention provides a storage system for storing documents, the storage system comprising securing means for securing the documents, a carriage for carrying the securing means, the carriage having location means for locating the securing means, and a support structure from which the carriage can be extended so that a face of the secured documents can be viewed.

The advantage of the present storage system is that the face of the documents on each carriage can be viewed conveniently as the carriage is extended from the support structure. The user can easily and efficiently locate the relevant document(s) in the storage system from the displayed face.

In one embodiment, the securing means may comprise a set of lever arch ring fasteners which can be opened and closed to release and secure documents having a perforated edge.

The securing means may comprise a base portion and a fastener attached to the base portion. Typically, the base portion provides a fiat surface on which the documents can rest when the fastener secures the document with respect to the base portion. The base portion may define a pair of parallel trenches for engagement with the carriage. Ho) Having securing means in the storage system advantageously removes the need for users to employ additional folders/files and/or stationary to organise the documents. Accordingly, the documents can be sorted and directly secured in the storage system.

The carriage may be a rack. In one embodiment, the rack may have location means in the form of one or more support bars, which can be received by the securing means.

Typically, the location means comprise a pair of parallel support bars between which the securing means can be located, at many locations along an axis. The support bars may extend transversely to a direction of extension of the carriage.

The support bars may be received by the parallel trenches of the base portion, which advantageously allows the securing means to be easily removed from or located on the carriage. Further, the location means of each carriage allow the securing, means to be located appropriately within the storage system in a tidy and organised manner.

The carriage may have a pair of side members which are supported by the support structure. The side members may be parallel. The support structure may have a pair of corresponding rails to engage with the side members and support the carriage. The side members may each have rollers which rotate on the rails to facilitate the carriage to be extended from and retracted into the support structure.

Typically, the carriage is disposed substantially horizontally with respect to the support structure.

The securing means may comprise label holders which can be used to hold labels or name tags identifying the documents on the securing means.

The support structure may have a rectangular shape. The support structure may have two opposing side walls and a top cover. The carriage may be supported from the two opposing side walls. For example, the first portion of the side rails may be attached to the two opposing side walls.

The support structure may support a plurality of carriages. The plurality of carriages may be arranged in one or more rows and columns.

In addition, each carriage may carry one or more securing means and the securing means may be arranged side by side. Typically, each carriage carries two securing means side by side.

The storage system may be manufactured in modules and a number of storage systems may be placed and stacked together to form a storage system of any desirable size and storage capacity.

Each storage system, carriage and/or securing means may be colour coded to assist the organisation of the documents.

Each storage system may be provided in kit form with instructions for a user to assemble the storage system.

According to another aspect of the invention, there is provided a kit for assembling a storage system for storing documents, the kit comprising:
securing means for securing the documents,
a carriage for carrying the securing means, the carriage having location means for locating the securing means, and
a support structure for supporting the carriage,
wherein when the kit is assembled, the carriage can be extended from the support structure so that a face of the secured documents can be viewed.

These and other features and advantages of the invention will become apparent to those skilled in the art from the following description and the accompanying drawing. It should be understood, however. that the detailed description and specific examples, while indicating a preferred embodiment of the present invention, are given by way of illustration and not of limitation. Many changes and modifications may be made within the scope of the present invention without departing from the spirit thereof, and the invention includes all such modifications.

In order that the invention may be more readily understood and put into practice, one or more preferred embodiments thereof will now be described, by way of example only, with reference to the accompanying drawings.

### BRIEF DESCRIPTION OF THE DRAWINGS

FIG. 1 illustrates a storage system according to an embodiment of the invention.

FIG. 2 is a side view of a document securing means according to the embodiment of the invention illustrated in FIG. 1.

FIG. 3 shows a number of a labelled securing means according to an embodiment of the invention.

FIG. 4 shows a number of adjacent storage systems according to an embodiment of the invention.

### DETAILED DESCRIPTION OF PREFERRED EMBODIMENT(S)

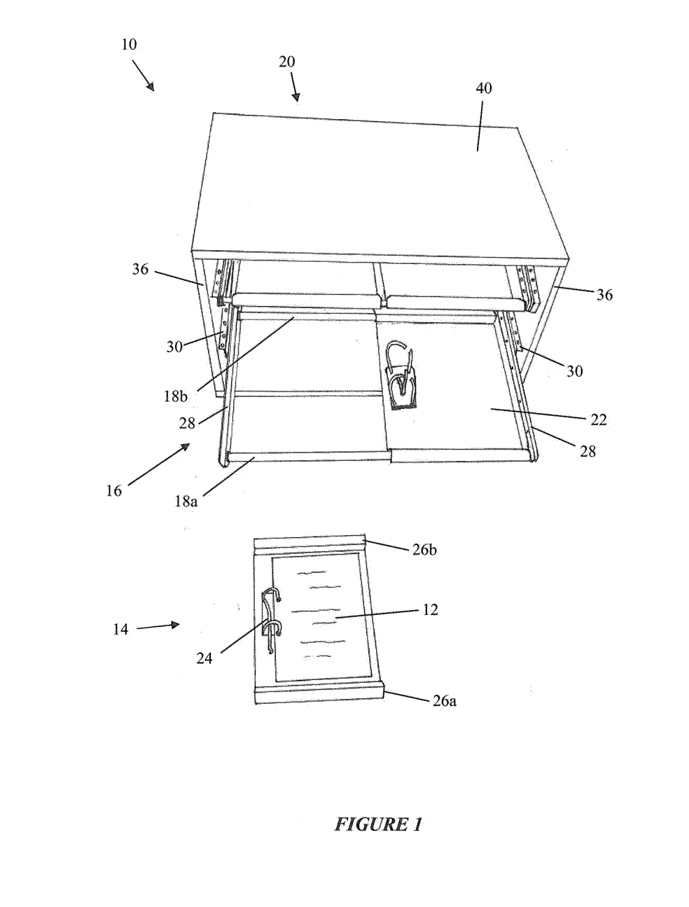

As illustrated in FIG. 1, the invention provides a storage system 10 for storing documents 12. The storage system 10 comprises four securing means 14 for securing the documents 12, and two carriages 16 each carrying a pair of securing means 14. The carriage 16 has location means in the form of parallel support bars 18a and 18b for locating the securing means 14. A support structure 20 is provided from which the carriage 16 can be extended so that a face of the secured documents 12 can be viewed.

The advantage of the storage system 10 is that the face of the documents on each carriage 16 can be viewed conveniently as the carriage 16 is extended from the support structure 20. The user can easily and efficiently locate the relevant document(s) 12 in the storage system 10 from the displayed face.

The securing means 14 comprises a base portion 22 and a set of lever arch ring fasteners 24. The lever arch ring fasteners 24 are disposed on one side of the base portion 22. The lever arch ring fasteners 24 can be opened and closed to release and secure documents 12 having a perforated (i.e. hole punched) edge. The base portion 22 provides a flat surface on which the documents 12 can rest when the fastener 22 secures the documents 12.

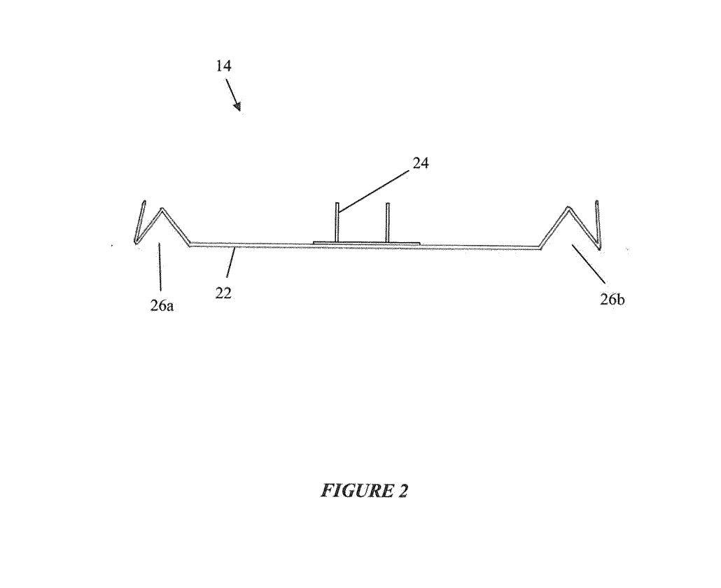

As shown in FIGS. 1 and 2, the base portion 22 comprises a pair of parallel trenches 26a and 26b along opposite sides of the based portion 22. The parallel trenches 26a and 26b are configured for engagement with the support bars 18a and 18b of the carriage respectively. The parallel bars 18a and I 8b extend transversely to the direction of extension of the carriage 16.

When the securing means 14 is carried by the carnage 16, the securing means 14 is located between the parallel support bars 18a and 18b, and the parallel support bars 18a and 18b are respectively received in the parallel trenches 26a and 26h. Accordingly, the securing means 14 can be located at many locations along the parallel support bars 18.

The carriage 16 has a pair of side members 28 which are supported by the support structure 20. For each pair of side members 28, a pair of corresponding rails 30 is provided on the support structure 20. Each side member 28 comprises a set of rollers which rotate along the corresponding rails 30 to enable the carriage to extend and retract with respect to the support structure 20.

The carriage 16 is disposed substantially horizontally with respect to the support structure 20.

The support structure 20 has a rectangular shape. The support structure 20 has two opposing side walls 36 and a top cover 40. The rails 30 are attached to the inner surfaces of the two opposing side walls 36.

FIG. 2 illustrates a. side view of the document securing means 14. As previously mentioned, the securing means 14 has a base portion 12, a lever arch ring fastener 24 and a pair of parallel trenches 26a and 26b disposed along opposite sides of the base portion 12.

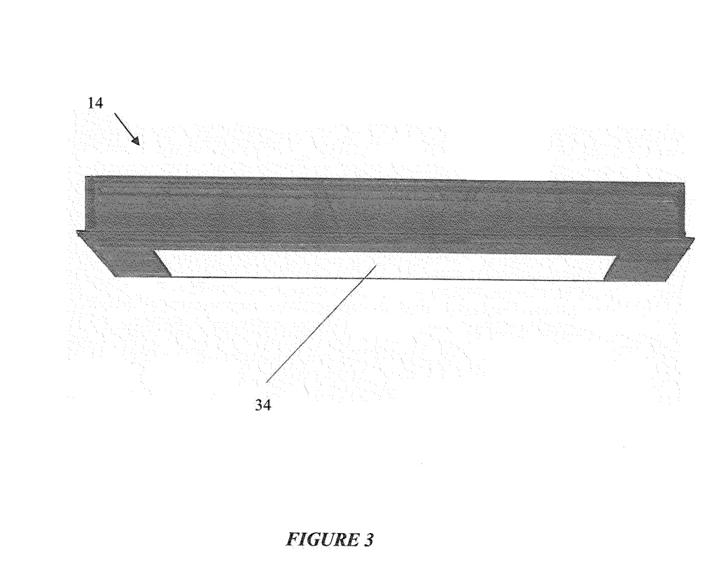

As illustrated in FIG. 3, each securing means 14 has a label holder 34 which can be used to hold a label identifying the documents 12 on the securing means 14. The label holder 34 is a transparent pocket into which a label can be inserted.

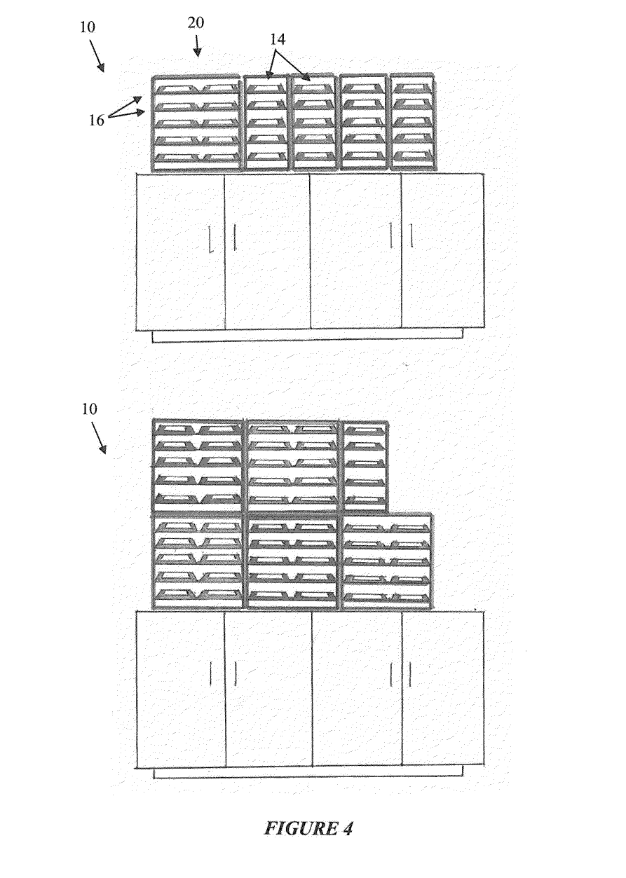

As shown in FIG. 4, the storage system 10 can be manufactured in modules and a number of storage systems 10 may be placed and stacked together to form a storage system of any desirable size and capacity. The storage system modules 10 can be small enough to be placed in any convenient location, for example, directly on the floor, or on top of cupboards.

Each storage system, carriage and/or securing means can be colour coded to assist the organisation of the documents.

In addition, each storage system can be provided in kit form with instructions for a user to assemble the storage system 10.

When a user wishes to locate a particular document in the storage system 10, the user can extend the carriages 16 and view the face of the documents 12 to determine the correct document.

The foregoing embodiments are illustrative only of the principles of the invention, and various modifications and changes will readily occur to those skilled in the art. The invention is capable of being practiced and carried out in various ways and in other embodiments. It is also to be understood that the terminology employed herein is for the purpose of description and should not be regarded as limiting.

In an alternative embodiment, the lever arch ring fasteners 24 can be replaced by any suitable type of fastener, for example the fastener may comprise one or more clips, clamps, pins, or a combination thereof.

In another alternative embodiment, the location means may define recesses which releasably engage with corresponding protrusions of the securing means.

Instead of having the carriage arranged horizontally with respect to the support structure, the carriage may be disposed at a slight incline from the horizontal.

It will be appreciated that the angle of the parallel trenches 26a and 26b, as shown in

FIG. 2, can be any suitable angle, including a 90° angle.

In a further alternative embodiment, the support structure may comprise a frame. The frame may have four generally vertical support legs. The carriage may be attached to the support legs for support. The frame may provide rails on which the carriage can move, thereby enabling the carriage to extend and retract.

To assist stacking and joining of modular storage systems, the support structure may have fasteners disposed on an outer side of the support structure. For example, the support structures may comprise one or more brackets, hooks, clips, clamps, hook and loop fasteners, protrusions/recesses, pins, apertures, grooves, ledges, or a combination thereof, to allow adjacent storage systems to lock together.

The term “comprise” and variants of that term such as “comprises” or “comprising” are used herein to denote the inclusion of a stated integer or integers but not to exclude any other integer or any other integers, unless in the context or usage an exclusive interpretation of the term is required.

Reference to prior art disclosures in this specification is not an admission that the disclosures constitute common general knowledge in Australia or any other country.

1. A storage system for storing documents, the storage system comprising
securing means for securing the documents,
a carriage for carrying the securing means, the carriage having location means for locating the securing means, and
a support structure from which the carriage can be extended so that a face of the secured documents can be viewed.

2. The storage system as claimed in claim 1, wherein the securing means comprises a set of lever arch ring fasteners which can be opened and closed to release and secure documents having a perforated edge.

3. The storage system as claimed in claim 1, wherein the securing means comprises a base portion and a fastener attached to the base portion, the base portion providing a flat surface on which the documents can rest when the fastener secures the document with respect to the base portion.

4. The storage system as claimed in claim 3, wherein the base portion defines a pair of parallel trenches for engagement with the carriage.

5. The storage system as claimed in claim 1, wherein the carriage comprises a rack, the rack having location means in the form of one or more support bars, which can be received by the securing means.

6. The storage system as claimed in claim 5, wherein the location means comprise a pair of parallel support bars between which the securing means can be located, at many locations along an axis.

7. The storage system as claimed in claim 5. wherein the support bars extend transversely to a direction of extension of the carriage.

8. The storage system as claimed in claim 5, wherein the support bars are received by parallel trenches of the securing means.

9. The storage system as claimed in claim 1, wherein the carriage has a pair of parallel side members which are supported by the support structure.

10. The storage system as claimed in claim 9, wherein each side member has rollers which rotate to facilitate the carriage to be extended from and retracted into the support structure.

11. The storage system as claimed in claim 9, wherein the support structure has a pair of corresponding rails to engage with the side members and support the carriage.

12. The storage system as claimed in claim 1, wherein the carriage is disposed substantially horizontally with respect to the support structure.

13. The storage system as claimed in claim 1, wherein the securing means comprise label holders which can be used to hold labels or name tags identifying the documents on the securing means.

14. The storage system as claimed in claim 1, wherein the support structure has a generally rectangular shape.

15. The storage system as claimed in claim I, wherein the support structure has two opposing side walls and a top cover.

16. The storage system as claimed in claim 15, wherein the carriage is supported from the two opposing side walls.

17. The storage system as claimed in claim 1, wherein the support structure supports a plurality of carriages, the plurality of carriages being arranged in one or more rows and columns.

18. The storage system as claimed in claim 1, wherein each carriage car more securing means and the securing means are arranged side by side.

19. The storage system as claimed in claim 1, wherein the storage system is stackable with other storage systems.

20. A kit for assembling a storage system for storing documents, the kit comprising:
securing means for securing the documents,
a carriage, for carrying the securing means, the carriage having location means for locating the securing means, and
a support structure for supporting the carriage,
wherein when the kit is assembled, the carriage can be extended from the support structure so that a face of the secured documents can be viewed.
